(19) United States
(12) Patent Application Publication
(10) Pub. No.: US 2007/0222717 A1
(43) Pub. Date: Sep. 27, 2007

(54) Organic El Display Device

(76) Inventors: Jun Maede, Kyoto (JP); Shinichi Abe, Kyoto (JP); Masanori Fujisawa, Kyoto (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/578,064

(22) PCT Filed: Apr. 8, 2005
(86) PCT No.: PCT/JP05/06933

§ 371 Date: Oct. 12, 2006

(30) Foreign Application Priority Data
Apr. 13, 2004 (JP) 2004-117488

(51) Int. Cl. G09G 3/30

(52) U.S. Cl. 345/76

(57) ABSTRACT

An organic EL display device has a high resolution in which an organic EL panel current is driven by a plurality of current drive ICs (current drivers). The occupation area required for the current drive circuits is suppressed and unevenness in luminance of the display screen is reduced. The EL panel has first and second current drivers which output drive currents corresponding to display data to terminal pins via output terminals to drive the organic EL panel, which are respectively provided with a plurality of output terminals and a plurality of connection switch circuits. The connection switch circuits are provided inside the organic EL panel and n (n≧1) pieces of respective output terminals for the first and second driver are alternatively switched and connected to n pieces of respective column lines (drive lines at the anode side of an organic EL element).

### TECHNICAL FIELD

The present invention relates to an organic EL display device and, more specifically, relates to an organic EL device suitable for an organic EL panel having a high resolution, in which in the organic EL panel current driven by a plurality of current drive ICs (current drivers) via terminal pins at the column side (column pins) an increase of an occupation area for current drive circuits is suppressed and product by product dispersion in luminance of the display device and unevenness in luminance of the display screen are reduced.

### BACKGROUND ART

For an organic EL display panel in an organic EL display device which is mounted on such as a cellular phone, PHS, and PDA (Personal Digital Assistant), one in which the number of terminal pins at the column side connected to column lines (anode side drive line for an organic EL element) is 396 (132×3) and the number of terminal pins at the row side connected to row lines (cathode side drive line for an organic EL elements) is 162 has been proposed, and the number of the terminal pins at the column side and the row side tends to increase more than that proposed.

As a drive circuit for such organic EL display panel, JP2003-234655A (Patent Document 1) of the present applicant discloses a provision of D/A converter circuits (herein below will be called as D/A) for column pins, in which circuit the D/As provided for the column pins receive display data and a reference drive current, D/A convert the display data according to the reference drive current and produce respective drive currents or base currents for the drive currents for respective column pins.

Patent Document 1: JP2003-234655A

In order to reduce power consumption, a power source voltage for the D/A is suppressed low, for example, to about DC 3V, only a power source voltage in an output stage current source at the final stage is set, for example, at DC 15V˜20V, and the respective D/As provided for the respective column pins (or the respective output terminals of the driver IC) receive the distributed reference drive current for the respective column pins (or the respective output terminals of the driver IC) and produce base currents for the drive currents of the organic EL elements (herein below will be called as OEL element) to drive the output stage current source. Thereby, the power consumption by the entire current drive circuits is suppressed low. However, when the D/As are formed into an IC, the D/As are required to be provided for the corresponding output terminal pins, for this reason in order to suppress the occupation area at the present, one having about 4 bits˜6 bits is produced.

The reference drive current fed to the respective D/As is a reference current distributed by the reference current distributing circuit, which is constituted by a current mirror circuit having k pieces of output side transistors (the number k corresponds to the number of terminal pins to which output terminals of current drivers are connected) with respect to one piece of input side transistor. Thus, the input side transistor in the current mirror circuit receives the reference current from a reference current generating circuit and the output side transistors provided for the respective terminal pins distribute current to the D/As provided for the respective terminal pins.

### BRIEF DESCRIPTION OF THE DRAWING

FIG. 1 is a block diagram of an embodiment to which an organic EL display device according to the present invention is applied.

FIG. 2 is views for explaining switching states of column lines in the embodiment.

FIG. 3 is views for explaining timing signals at the time of driver switching.

FIG. 4 is a block diagram of another embodiment to which an organic EL display device according to the present invention is applied.

FIG. 5 is a view for explaining a column line connection switch circuit in the embodiment.

### DISCLOSURE OF THE INVENTION

### Problems to be Solved by the Invention

In a driver IC for an EL panel, since even for colors of R, G and B respective output terminals of more than 30 pins are respectively provided and the reference current distributing circuit is required to produce many number of reference currents corresponding to the number of output terminals and distributes the same for the D/As provided for these output terminals, a dispersion in the respective distributed reference currents is likely caused in relation to the characteristic difference of the output side transistors and their arrangement in the reference current distributing circuit, which arises the product by product dispersion in luminance of the display device and unevenness in luminance of the display screen.

When the drive circuit for the organic EL panel drives an output stage current source by using D/As of about 4 bits ˜6 bits and drives the OEL elements respectively via the respective column pins (respective output terminals), because of poor current conversion accuracy of the D/As, a dispersion in drive currents for the corresponding column pins is likely caused, which also arises the product by product dispersion in luminance of the display device and unevenness in luminance of the display screen.

For this reason, the driver IC is required, in addition to the adjustment function of the reference current, to have a separate adjustment circuit for adjusting the reference current at the D/A side for every input terminal, which causes a problem of increasing the occupation area thereby.

On one hand, in order to enhance the conversion accuracy of the D/As, when D/As having 6 bits or more are used, since the D/As have to be provided for respective column pins, the occupation area of the current drive circuits in the driver IC increases, which causes a problem to limit the number of the output terminals corresponding thereto.

An object of the present invention is to solve the conventional problems and to provide an organic EL display device which permits to suppress an increase of an occupation area for current drive circuits in the current drive IC and to reduce dispersion in luminance and unevenness in luminance of the display device.

Another object of the present invention is to provide an organic EL display device, which permits to reduce dispersion in luminance and unevenness in luminance of the display device and is suitable for an organic EL panel having a high resolution.

### MEASURES FOR SOLVING THE TASKS

A constitution of an organic EL display device according to a first aspect of the present invention, which achieves these objects, includes a first and second driver which output drive currents corresponding to display data to terminal pins of an organic EL panel via output terminals and current drive the organic EL panel, wherein the first and second driver are respectively provided with many number of the output terminals and comprises many number of connection switch circuits which are provided in the organic EL panel and connect alternatively n (n is an integer of 1 or more than 1) pieces of the respective output terminals for the first driver to one and other of two groups of n pieces, the two groups are obtained by dividing the drive lines of adjacent 2n pieces at the anode sides of adjacent organic EL elements or the data lines of adjacent 2n pieces by 2, and further connect alternatively n pieces of the respective output terminals for the second driver to other and one of remaining n pieces of the driver lines or the data lines in response to control signals, and a control circuit which generates the control signals for every m (m is an integer of 1 or more than 1) frames or for every m horizontal lines and switches the many number of the connection switch circuits at the same time.

In an organic EL display device including k (k is an integer of 3 or more than 3) pieces of drivers for current driving the organic panel according to a second aspect of the present invention, the many number of the connection switch circuits connect respectively n (n is an integer of 1 or more than 1) pieces of the respective output terminals for one driver among k pieces of the drivers to one of k groups of n pieces, the k groups are obtained by dividing the drive lines of adjacent k·n pieces at the anode sides of adjacent organic EL elements or the data lines of adjacent k·n pieces by k, connect n pieces of the respective output terminals for another driver among the k pieces of drivers to n pieces of drive lines or the data lines in one remaining group and further connect n pieces of the respective output terminals for a remaining driver among the k pieces of drivers to n pieces of drive lines or the data lines in another remaining group in response to control signals.

### ADVANTAGE OF THE INVENTION

As has been explained above, according to the first aspect of the present invention, the connection switch circuits are provided inside the organic EL panel and the n pieces of respective output terminals for the first and second driver are alternatively switched and connected to n pieces of respective column lines (a drive line at the anode side of an organic EL element) or respective data lines among 2n pieces of the respective column lines or the respective data lines for every m frames or m horizontal lines by the connection switch circuits.

Thereby, the n pieces of respective adjacent column lines (or the respective adjacent data lines, herein below will be represented by column line) respectively receive drive currents from the two drivers in time sharing manner in response to the switching. Since OEL elements connected to a certain column line are driven by the drive currents from the respective drivers for every m frames or for every m horizontal lines, the emission luminance of the OEL elements is integrated with regard to time in the n pieces of respective column lines and averaged.

Further, for displaying images, the first and second driver alternatively distribute display data for respective m frames or m horizontal lines using n pixels on one horizontal line as a unit for storing the same. The switching by the connection switch circuits are performed in response to the stored display data and the drive currents in response to the stored display data are generated to the respective output terminals for the first and second driver.

In the second aspect of the present invention, the number of the drivers according to the first aspect of the present invention is selected not less than 3 and the simultaneous switching of more than 3xn lines is performed, and the same advantages as above are obtained therewith.

As a result, even if there is dispersion in the respective reference currents for the output terminals produced for the terminal pins or because of somewhat poor current conversion accuracy of the respective D/As for the output terminals which convert the display data according to the respective reference currents, even if there arises dispersion in the resultant drive currents between terminal pins, dispersion in luminance of the display device and unevenness in luminance of the display screen are reduced.

Further, since the output terminals of the first and second driver are alternatively connected to the terminal pins with a unit of n respectively, the pitch of the column lines with respect to the terminal pin pitch of the respective drivers is doubled, thereby, an organic EL display device having a high resolution is easily realized.

### BEST MODES FOR CARRYING OUT THE INVENTION

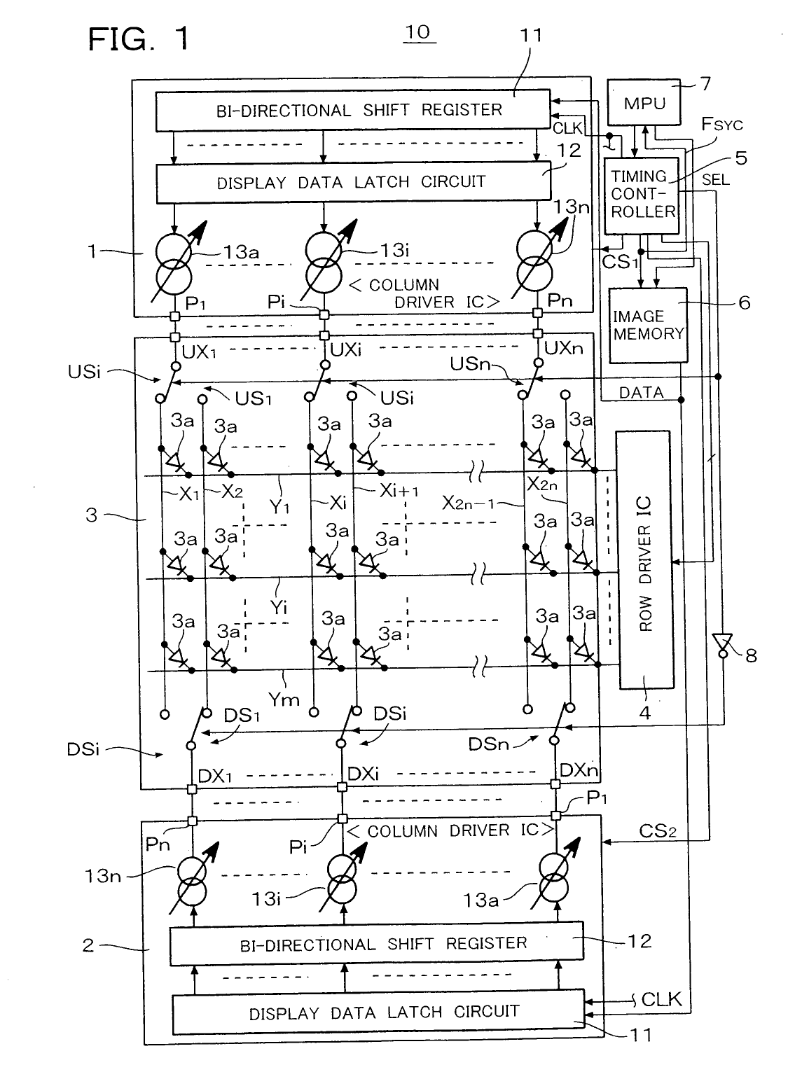

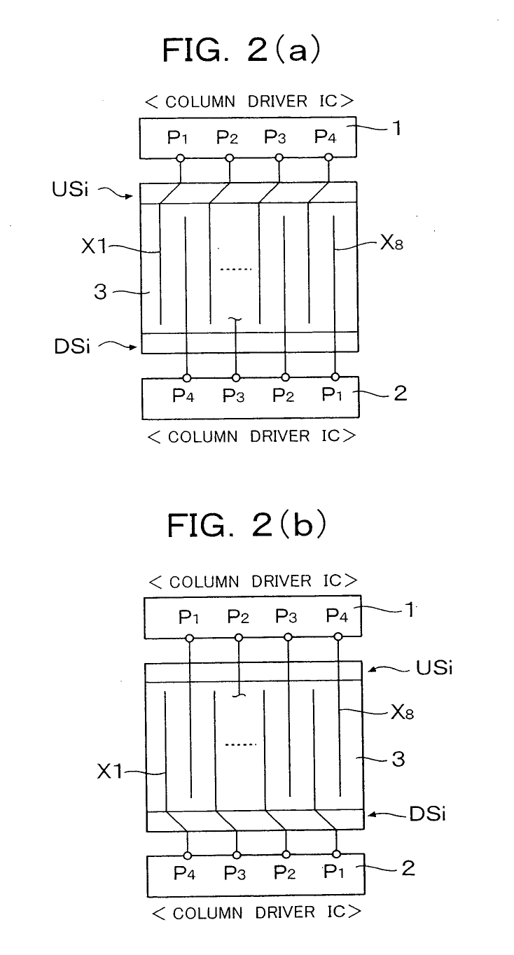

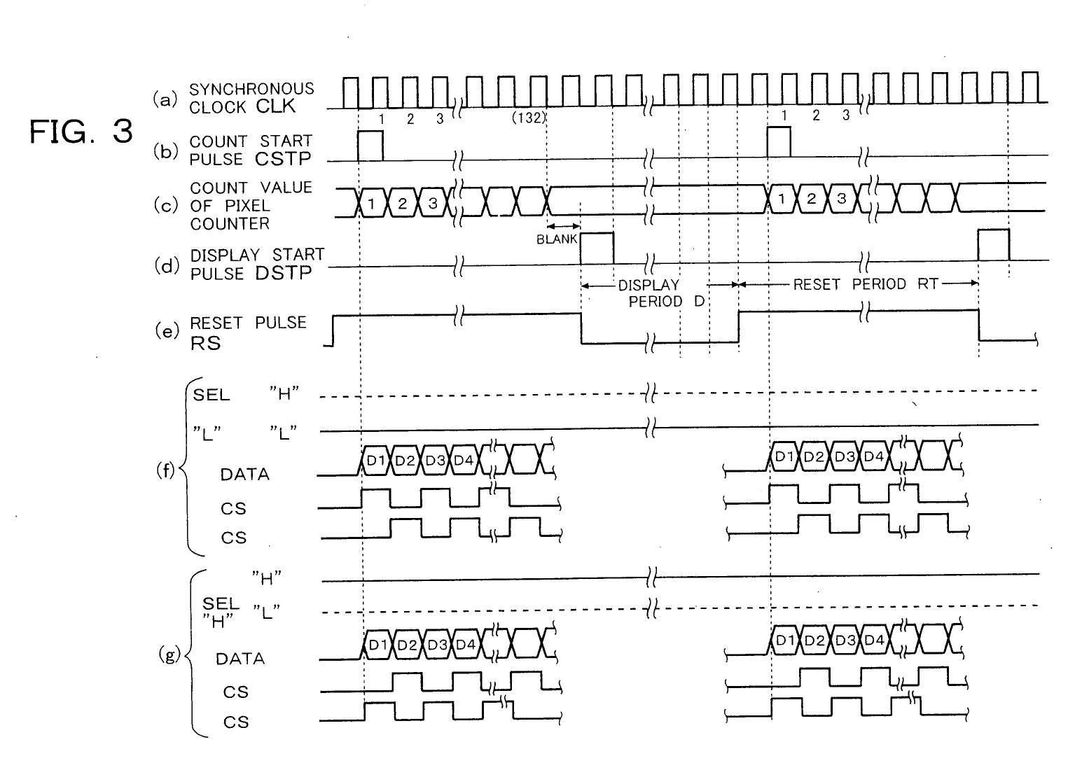

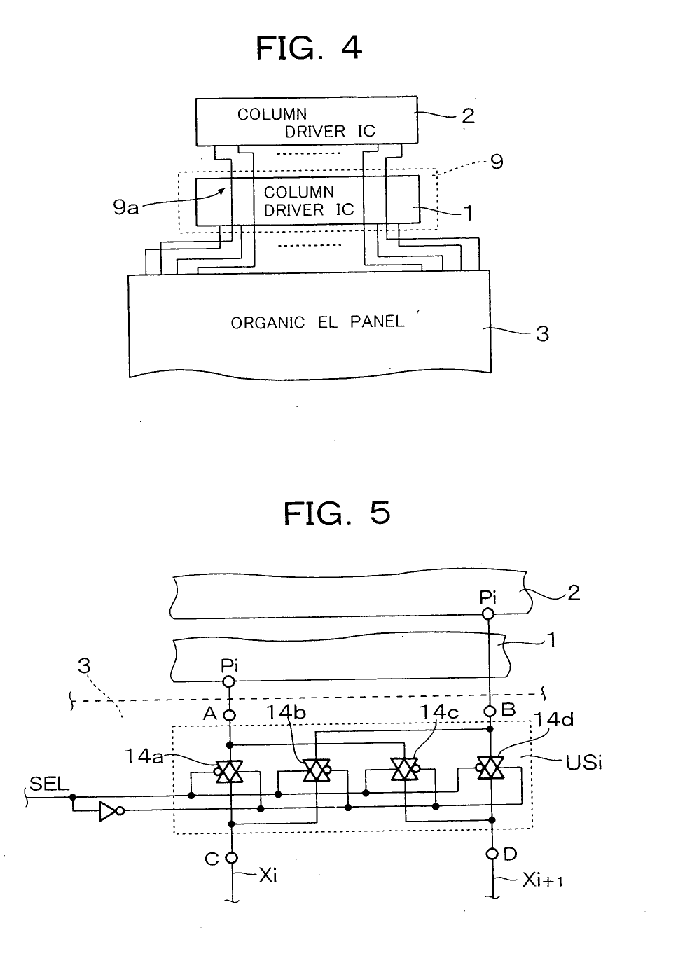

FIG. 1 is a block diagram of an embodiment to which an organic EL display device according to the present invention is applied, FIG. 2 is views for explaining switching states of column lines in the embodiment, FIG. 3 is views for explaining timing signals at the time of driver switching, FIG. 4 is a block diagram of another embodiment to which an organic EL display device according to the present invention is applied, and FIG. 5 is a view for explaining a column line connection switch circuit in the embodiment.

In FIG. 1, 10 is an organic EL display device, which is constituted by column driver ICs (herein below will be simply called as column driver) 1 and 2 which send out drive currents to the anodes of OEL elements and serve as current drivers, an organic EL panel 3, a row driver IC (herein below will be simply called as row driver) 4, a timing controller 5, an image memory (V-RAM) 6 and MPU 7.

In response to a frame synchronous signal FSYC corresponding to a vertical synchronous signal VSYC, display data for one frame amount are transferred from the MPU 7 to the image memory 6 in a period corresponding to a vertical retrace period and are stored therein.

The timing controller 5 sends out the frame synchronous signal FSYC to the image memory 6 and the MPU 7. Further, FSYC is a pulse generated every 1/30 sec. or 1/60 sec.

The timing controller 5 generates a predetermined timing signal to the column drivers 1 and 2, the row driver 4 and the image memory 6, and sends out display data from the image memory 6 to the column drivers 1 and 2. The column drivers 1 and 2 and row driver 4 perform scanning at the row side for the organic EL panel in response to the timing signal from the timing controller 5 as well as send out to the column side a current drive signal corresponding to display data DATA for one horizontal line at respective moment so as to current drive the organic EL panel 3.

Herein each of the column drivers 1 and 2 is allotted pixels for one horizontal line of every other line and drives the same. Thereby, images corresponding to the display data DATA are displayed on the organic EL panel 3.

The column drivers 1 and 2 are respectively constituted by a bi-directional shift register 11, a display data latch circuit 12 and variable current sources 13a˜13n provided so as to correspond to the terminal pins of the organic EL panel 3. The respective variable current sources 13 (as representing the variable current sources 13a˜13n) receive allotted own display data DATA from the display data latch circuit 12 and respectively send out drive currents in response to the values of the display data DATA to the allotted own output terminals among the output terminals P1˜Pn.

The display data latch circuit 12 allots the display data DATA for every one horizontal line sent out from the image memory (V-RAM) 6 to the column drivers 1 and 2 for respective pixels and stores the same. Further, the allotment of the display data DATA will be explained later.

The respective variable current sources 13 are usually constituted by a D/A converting circuit (D/A) and a current output circuit of a current mirror, the D/A receives display data DATA from the display data latch circuit 12 and a reference current distributed for the terminal pin by a reference current distributing circuit (not shown) and D/A converts the display data DATA, and by driving the current output circuit with the converted analog current the current output circuit generates a drive current in response to the value of the display data.

The organic EL panel is rectangular and inside thereof OEL elements 3a are arranged in a matrix. The anode side and cathode side of the respective OEL elements 3a are respectively connected to the column lines X1˜X2n and row lines Y1˜Ym at the crossing points thereof.

The terminal pins are respectively provided at the opposing top and bottom sides of the rectangle. The terminal pins at the top side are column pins UX1, . . . UXi, UXn, . . . and the respective terminal pins at the bottom side are column pins DX1, . . . DXi, . . . DXn.

Respective output terminals P1, . . . Pi, . . . Pn of the column driver 1 are connected to the respective column pins at the top side UX1, . . . UXi, . . . UXn so as to correspond thereto, and respective output terminals Pn, . . . Pi, . . . P1 of the column driver 2 are connected to the respective column pins at the bottom side DX1, . . . DXi, . . . DXn so as to correspond thereto.

Further, since the structure of the column driver 2 is the same as that of the column driver 1, when the column driver 2 is arranged at the bottom side, the alignment direction of the output terminals P1, . . . Pi, . . . Pn is inverted as illustrated.

The respective column pins UX1, . . . UXi, . . . UXn are connectable to respective adjacent two column lines Xi, Xi+1 (wherein i=an odd number integer) in the respective column lines X1, . . . X1, . . . X2n (double number of column pins at respective sides) via the respective connection switch circuits USi (US1, . . . USi, . . . USn, herein below will be called as switch circuit USi) at the bottom side of the organic EL panel 3. The respective column pins DX1, . . . DXi, . . . DXn are connectable to respective adjacent two column lines Xi, Xi+1 via the respective connection switch circuits DSi (DS1, . . . DSi, . . . DSn, herein below will be called as switch circuit DSi) at the top side of the organic EL panel 3. However, as illustrated, the column lines connectable to the respective switch circuits USi and DSi are alternated one to other so as not to overlap their connected columns each other.

In a period after completing the scanning at the row side for one frame corresponding to the vertical retrace period, a switch signal SEL of the timing controller 5 switches from “L” (=LOW level) to “H” (=HIGH level) or from “H” to “L”. Then, upon receipt of the switch signal “H” or “L”, the respective switch circuits USi switch the connection from one to the other between two column lines Xi and Xi+1. The respective switch circuits DSi receive the switch signal SEL via the inverter 8 and switch the connection oppositely from the other to the one. Further, when the switch terminals of the switch circuits DSi are arranged by inverting between right and left with respect to the switch circuits USi, for example, with regard to such as a transmission gate (CMOS analog switch) as shown in FIG. 5 in which the right side input and the left side input perform opposite terminal selecting operation with respect to a same control signal, since the switching in the upper side switch circuits and the bottom side switch circuits is performed in opposite directions, the inverter 8 is unnecessitated.

When the switch signal SEL is “L”, as shown in FIG. 2 (a), the respective switch circuits USi select respective column lines of odd number and the respective switch circuits DSi select respective column lines of even number. When the switch signal SEL is “H”, as shown in FIG. 2 (b), oppositely, the respective switch circuits USi select respective column lines of even number and contrary, the respective switch circuits DSi select respective column lines of odd number. Thus, the connection switching of respective column lines of odd number and even number for the respective output terminals P1˜Pn of the respective column drivers in response to the change between “H” and “L” of the switch signal SEL for every one frame is performed alternatively by the respective switch circuits USi and the respective switch circuits DSi in a complementary manner for one column line and the other column line and for the remaining other column line and the remaining one column for every one frame.

Further, for the sake of simplicity, an example of 4 output terminals (P1˜P4) and 8 column lines (X1˜X8) is illustrated in FIG. 2.

In response to the switch signal ESL of the timing controller 5, when the signal is “L”, in other words when the respective switch circuits USi select the respective column lines of odd number, the column driver 1 receives display data DATA of respective pixels of odd number from the image memory 6 and stores the same. Thereby, the column driver 1 generates drive currents for the respective column lines of odd number and for a display period D (see FIG. 3 (e)) following a reset period RT in response to the display data of the pixels of the corresponding column lines of odd number and drives respectively the respective column lines.

Since at this moment the switch circuits DSi select the respective column lines of even number, in response to the switch signal ESL (“L”) of the timing controller 5, the column driver 2 receives display data DATA of respective pixels of even number from the image memory 6 and stores the same, and the respective variable current sources 13 generate drive currents for the respective column lines of even number and for a display period D following a reset period RT in response to the display data of the pixels of the corresponding column lines of even number and drives respectively the respective column lines.

On the other hand, when the switch signal SEL of the timing controller 5 is “H”, the selection is inverted. Namely, the respective switch circuits USi select respective column lines of even number and the column driver 1 contrary to the above receives display data DATA of the respective pixels of even number and stores the same. In this instance, the respective switch circuits DSi also contrary to the above select respective column lines of odd number and the column driver 2 contrary to the above receives display data DATA of the respective pixels of odd number and stores the same. Thereby, with respect to the column driver 1, the respective variable current sources 13 respectively drive the respective column lines of even number in response to the display data of the corresponding column lines of even number, and with respect to the column driver 2, the respective variable current sources 13 respectively drive the respective column lines of odd number in response to the display data of the corresponding column lines of odd number.

Such switching processing for every one frame through the switch signal SEL will be explained according to FIG. 3

FIG. 3 is a view for explaining timing signals in the driver switching processing.

FIG. 3 (a) is synchronous clocks CLK serving as a base of timing for respective control signals, FIG. 3 (b) is counter start pulses CSTP of a pixel counter. Count values of the pixel counter are shown in FIG. 3 (c). FIG. 3 (d) is display start pulses DSTP and FIG. 3 (e) is reset pulses RS which are timing signals for sectioning the reset period RT corresponding to the retrace period and the display period D corresponding to the horizontal scan period.

FIG. 3 (f) shows display data D1, D2, D3, D4, . . . as DATA for every horizontal one line stored in the respective column drivers 1 and 2 in the respective reset period RT (see FIG. 3 (e)) for the scanning at the row side when the switch signal SEL is “L”.

The DATA is constituted by respective data D1, D2, . . . Dn (Dn is not shown) corresponding to one pixel for one horizontal line outputted to the image memory (V-RAM) 6 in the reset period RT. The respective data D1˜Dn are inputted to the bi-directional shift register 11 at the rising timing of the clock pulses CLK in FIG. 3 (a) and successively shifted. To the bi-directional shift register 11 in the column driver 1 the respective data D1˜Dn are inputted and shifted in opposite direction toward the first stage. On one hand, to the bi-directional shift register 11 in the column driver 2 the respective data D1˜Dn are inputted and shifted in forward direction from the first stage to the final stage. This is because the alignment direction of the output terminals of the column driver 2 is inverted from that of the column driver 1.

CS1 is a chip select signal of the column driver 1 and CS2 is a chip select signal of the column driver 2 and an inverted signal of the chip select signal CS1. At the timing “H” thereof, the column drivers 1 and 2 are enabled and one of the respective data D1˜Dn is fetched to the bi-directional shift register 11.

As a result, the data D1˜Dn for the horizontal one line component are alternatively fetched to the column drivers 1 and 2.

When the switch signal SEL is “L” at a certain frame timing, display data for respective pixels of odd number are fetched to the bi-directional shift register 11 in the column driver 1 and the respective switch circuits USi select respective column lines of odd number and connect thereto. Display data for respective pixels of even number are fetched in the opposite direction to the bi-directional shift register 11 in the column driver 2 and the respective switch circuits DSi select respective column lines of even number and connect thereto.

In the following frame the switch signal SEL turns to “H”, in this instance, as shown in FIG. 3 (g), the phases of the chip select signal (selection signal) CS1 and the chip select signal (selection signal) CS2 are inverted, the display data for respective pixels of even number are fetched to the bi-directional shift register 11 in the column driver 1 and the display data for respective pixels of odd number are fetched to the bi-directional shift register 11 in the column driver 2. Accordingly, the odd number and even number of the pixel positions with regard to the display data corresponding to the pixels stored are inverted as the above instance. In this instance, the respective switch circuits USi and DSi are in an inverted connecting relation as in the above.

Further, the display data fetched to the bi-directional shift register 11 are set to the data latch circuit 12 after the display data for the last pixel has been fetched and are distributed to the respective variable current sources 13 so as to correspond to the respective output terminals P1, . . . Pi, . . . Pn.

As a result, by means of the switch signal SEL which alternatively repeats “L” and “H” for every one frame the respective column lines X (as one of X1, . . . X1, . . . X2n) are selected in the order of odd number, even number, odd number, even number, . . . for every one frame and the drive currents of the column driver 1 are output from the respective output pins P1, . . . Pi, . . . Pn to the respective selected column lines via the respective column pins UX1, . . . UXi, . . . UXn in the organic EL panel 3. At the same time, the respective column lines are selected in the opposite order of even number, odd number, even number, odd number, . . . for every one frame and the drive currents of the column driver 2 are output from the respective output pins P1, . . . Pi, . . . Pn to the respective selected column lines via the respective column pins DX1, . . . DXi, . . . DXn in the organic EL panel 3.

As has been explained above, the respective column lines are driven respectively by different column driver 1 or 2 alternatively for every one frame in time sharing manner. Thereby, the emission luminance of the respective OEL elements 3a (see FIG. 1) for horizontal one line component connected to the respective column lines is integrated with regard to time to give an averaged luminance.

As a result, the respective OEL elements emit light with an averaged luminance by means of the column drivers 1 and 2. Thereby, the unevenness in luminance of the display screen is prevented.

Accordingly, even if there is dispersion in the respective reference currents corresponding to the terminal pins or because of somewhat poor current conversion accuracy of the respective D/As, even if there arise dispersion in the resultant drive currents between terminal pins, such as the dispersion in luminance of the OEL elements and the unevenness in luminance are reduced.

Moreover, in the present embodiment, since the column driver 1 and the column driver 2 are disposed separately at the top and bottom portions, the pitch of the column lines of the organic EL panel 3 is ½ pitch with respect to the pitch of the output terminals of the column driver 1 and the column driver 2. Therefore, a current drive circuit constituted by the column driver 1 and the column driver 2 can drive the organic EL panel 3 having a high resolution of two times with respect to the pin pitch.

FIG. 4 is a view for explaining another embodiment to which an organic EL display device according to the present invention is applied. In FIG. 4, an insulation film 9 is provided between the column drivers 1 and 2, and the column drivers 1 and 2 are disposed at the front and back positions. The respective output terminals of the column driver 2 and the respective terminal pins of the organic EL panel 3 are connected by a group of wiring lines 9a corresponding to the respective output terminals on the insulation film 9 provided on the upper face of the column driver 1. Thereby, the respective output terminals P1, . . . Pi, . . . Pn of the column driver 1 and the column driver 2 are connected alternatively to the respective terminal pins.

Further, although the group of the wiring lines 9a can be wired under the column driver, in the present embodiment, the group of the wiring lines is provided over the column driver 1 for clarifying the connection relation thereof.

In this instance, in connection with the connection switching of the column lines by the switch signal SEL, the switch circuits DSi disposed at the bottom side of the organic EL panel 3 are eliminated and only the switch circuits at the upper side are used. For such switch circuits USi the switch circuit USi as shown in FIG. 5 is used.

FIG. 5 is a specific example of the switch circuit USi as shown in FIG. 4, and a single switch circuit USi (wherein, i=an integer of odd number and even number is excluded) is constituted by 4 analog switches (transmission gate) 14a˜14d. Its input terminal A is connected to the output terminal Pi of the column driver 1, and its input terminal B is connected to the output terminal Pi+1 of the column driver 2. The output terminal C is connected to the column line Xi and the output terminal D is connected to the column line Xi+1.

The analog switch 14a is connected between the input terminal A and the output terminal C, and the analog switch 14b is connected between the input terminal B and the output terminal C. Further, the analog switch 14c is connected between the input terminal A and the output terminal D, and the analog switch 14d is connected between the input terminal B and the output terminal D.

The respective analog switches 14a and 14d are turned ON, when the switch signal SEL is “L”, and turned OFF, when the switch signal SEL is “H”. Contrary, the respective analog switches 14b and 14c are turned OFF, when the switch signal SEL is “L”, and turned ON, when the switch signal SEL is “H”.

Herein, when assuming that i is odd number, and when the switch signal USi is “L”, the switch circuits USi connect the respective output terminals P1, . . . Pi, . . . Pn of the column driver 1 to the respective column lines X of odd number, and the respective output terminals P1, . . . Pi, . . . Pn of the column driver 2 to the respective column lines X of even number. When the switch signal USi is “H”, the switch circuits USi contrary connect the respective output terminals P1, . . . Pi, . . . Pn of the column driver 2 to the respective column lines X of odd number, and the respective output terminals P1, . . . Pi, . . . Pn of the column driver 1 to the respective column lines X of even number.

Thereby, the column drivers 1 and 2 (the output terminals P1, . . . Pi, . . . Pn thereof) can be positioned only one side of the upper and bottom side of the organic EL panel 3. As a result, an organic EL panel having area of two times formed by butting the two pieces of the organic EL panels 3 vertically can be driven.

Further, in FIG. 4, although the column driver 1 and the column driver 2 are disposed in parallel, these can be stacked. Still further, a plurality of the column drivers 1 and the column drivers 2 can be aligned along one side of the organic EL panel 3.

Although in the present embodiment, a color organic EL panel of R, G and B has not been referred to, the present embodiment can be switched for the respective colors R, G and B. In this instance, in connection with the terminal pins, the adjacent terminal pin for color R is a subsequent terminal pin for color R interposing terminal pins for colors G and B therebetween. The same is true with regard to terminal pins for colors G and B.

Accordingly, in the case of colors R, G and B, the adjacent pin or the adjacent column in the present invention indicates adjacent one with regard to the same display color.

Accordingly, the term adjacent used in the present specification and claims implies, in the case of color organic EL panel, adjacent one with regard to the same display color.

As a specific embodiment therefor, one column driver is added to FIG. 4 embodiment having two column drivers so as to include three column drivers each for one of three colors R, G and B. In this instance, the outputs from the three column drivers are successively connected in a predetermined order. Then, the switching connection for respective colors between adjacent three output terminals for R, G and B and the following adjacent three output terminals for R, G and B is performed beyond two output terminals for other two colors.

In this instance, inside the organic EL panel 3, the switching between 6 column lines consisting of three column lines for R, G and B and three column lines for R, G and B adjacent thereto is performed at the same time for every three column lines for R, G and B. The terminals and the column lines are switched while interposing any two terminals among ones for R, G and B or any two lines therebetween.

As a switching circuit for the above, for example, when the switch circuit USi as shown in FIG. 5 is assigned for R, between the input terminals A and B, and between the output terminals C and D in FIG. 5 two column lines Xi for G and B, and thereafter two column lines Xi+1 for G and B are added. Then, in response the modification, other two input terminals A and B for switching the respective column lines for G and B are added between the input terminals A and B in FIG. 5, and other two output terminals C and D for switching the respective column lines for G and B are added after the output terminals C and D.

Now, in the present embodiment, although the display data DATA on one horizontal line are distributed to the respective driver ICs by one pixel unit, the distribution of the display data DATA can be performed by k (k is an integer of 1 or more than 1) pixel unit. In this instance, since the switch circuits perform switching by k pixel unit, the respective n output terminals of the two driver ICs are connected alternatively for every k terminals to the 2n terminal pins of the organic panel. In this instance, n=p·k (p is an integer of 1 or more than 1). In this instance, k pieces of driver ICs can be provided. The pixel number 2n on one horizontal line is 2n=q·k (q is an integer of 1 or more than 1).

In FIG. 1 embodiment, although one column side driver IC is provided respectively at the upper and bottom side for the organic EL panel 3, two or more column side driver ICs can of course be provided respectively at the upper and bottom side. In response to such modification, display data are distributed to the respective drivers for every n pixels and the switching is performed in response to the distribution.

In FIG. 4 embodiment, although the two driver ICs are provided at the upper side in front and back manner (or in a stacked manner), three or more driver ICs can be provided at the upper side in front and back manner so as to perform simultaneous or successive connection switching for continuous and adjacent 3 or more column lines.

Further, in the embodiments, although the selective switching of the adjacent column line is performed for every one frame, the selective switching can be of course performed for every m (m is an integer of 1 or more than 1) horizontal scanning lines or m frames.

### INDUSTRIAL APPLICABILITY

As has been explained above, in the present invention, since the emission luminance of OEL elements, which is induced by drive currents of a plurality of column drivers, is averaged through integration along time, an application of the present invention is not limited to a passive matrix type organic EL panel, but the present invention can of course be applied to an active matrix type organic EL panel in which capacitors in pixel circuits are charged by the drive currents. Further, in this instance, an anode side drive line serves as a data line.

Further, the output stage current source is not limited to that of current drain type, but a current sink type can of course be used.

1. An organic EL display device including a first and second driver which output drive currents corresponding to display data to terminal pins of an organic EL panel via output terminals and current drive the organic EL panel,
wherein the first and second driver are respectively provided with many number of the output terminals and,
comprising many number of connection switch circuits which are provided in the organic EL panel and connect alternatively n (n is an integer of 1 or more than 1) pieces of the respective output terminals for the first driver to one and other of two groups of n pieces, said two groups are obtained by dividing the drive lines of adjacent 2n pieces at the anode sides of adjacent organic EL elements or the data lines of adjacent 2n pieces by 2, and further connect alternatively n pieces of the respective output terminals for the second driver to other and one of remaining n pieces of the driver lines or the data lines in response to control signals and,
a control circuit which generates the control signals for every m (m is an integer of 1 or more than 1) frames or for every m horizontal lines and switches the many number of the connection switch circuits at the same time.

2. An organic EL display device according to claim 1, wherein the respective connection switch circuits are provided by a unit of 2n pieces between the adjacent 2n terminal pins and the adjacent 2n drive lines or data lines, the first and second driver are respectively an IC and the output terminals are alternatively connected to the respective terminal pins by a unit of n.

3. An organic EL display device according to claim 2, wherein the first and second driver respectively store the display data distributed alternatively by a unit of n pixels on one horizontal line and generate the drive currents in response to the stored display data for the respective output terminals.

4. An organic EL display device according to claim 3, wherein the first and second driver are for driving the drive lines at the anode side and the numeral n is 1.

5. An organic EL display device according to claim 3, wherein the first and second driver are for driving the drive lines at the anode side and the numerals m and n are respectively 1.

6. An organic EL display device according to claim 5, wherein the organic EL panel is a rectangle, the terminal pins are respectively provided at the opposing sides of the rectangle, the adjacent two terminal pins are allotted to the corresponding terminal pins at each of the respective opposing sides, the first and second driver are disposed facing the respective opposing sides and the many connection switch circuits are provided inside the organic EL panel facing the respective opposing sides.

7. An organic EL display device according to claim 6, further comprising an image memory for storing the display data for one frame component and wherein the control circuit generates selection signals alternatively for respectively selecting the first and second driver, selects alternatively the first and second driver and distributes alternatively the display data thereto by a unit of n pixels, and the first and second driver respectively fetch alternatively the display data by the unit of n pixels in response to the selection signals.

8. An organic EL display device according to claim 3, wherein the adjacent 2n terminal pins and the adjacent 2n drive lines are respectively positioned adjacent for every R, G and B, and the many connection switch circuits are provided respectively for every R, G and B.

9. An organic EL display device according to claim 3, wherein the first and second driver are disposed facing one side of the organic EL panel in front and back manner, and the organic EL panel is a passive matrix type.

10. An organic EL display device according to claim 3, wherein the first and second driver are disposed facing one side of the organic EL panel in a stacked manner, and the organic EL panel is a passive matrix type.

11. An organic EL display device including k (k is an integer of 3 or more than 3) pieces of drivers which output drive currents corresponding to display data to terminal pins of an organic EL panel via output terminals and current drive the organic EL panel,
comprising many number of connection switch circuits which are provided in the organic EL panel and connect respectively n (n is an integer of 1 or more than 1) pieces of the respective output terminals for one driver among k pieces of the drivers to one of k groups of n pieces, said k groups are obtained by dividing the drive lines of adjacent k·n pieces at the anode sides of adjacent organic EL elements or the data lines of adjacent k·n pieces by k, connect n pieces of the respective output terminals for another driver among the k pieces of drivers to n pieces of drive lines or the data lines in one remaining group and further connect n pieces of the respective output terminals for a remaining driver among the k pieces of drivers to n pieces of drive lines or the data lines in another remaining group in response to control signals and,
a control circuit which generates the control signals for every m (m is an integer of 1 or more than 1) frames or for every m horizontal lines and switches the many number of the connection switch circuits at the same time.

12. An organic EL display device according to claim 11, wherein the respective connection switch circuits are provided by a unit of k·n pieces between the adjacent k·n terminal pins and the adjacent k·n drive lines or data lines, the k pieces of drivers are respectively an IC and the output terminals are alternatively connected to the respective terminal pins by a unit of n.

13. An organic EL display device according to claim 12, wherein the k pieces of drivers respectively store the display data distributed alternatively by a unit of n pixels on one horizontal line and generate the drive currents in response to the stored display data for the respective output terminals.
